(19) United States
(12) Patent Application Publication
(10) Pub. No.: US 2023/0238855 A1
(43) Pub. Date: Jul. 27, 2023

(54) MOTOR

(71) Applicant: Mitsubishi Electric Corporation, Tokyo (JP)

(72) Inventor: Masaomi WASHINO, Tokyo (JP)

(73) Assignee: Mitsubishi Electric Corporation, Tokyo (JP)

(21) Appl. No.: 18/013,268

(22) PCT Filed: Aug. 28, 2020
(86) PCT No.: PCT/JP2020/032613

§ 371 Date: Dec. 28, 2022

(51) Int. Cl. H02K 7/00; H02K 5/06; H02K 5/173; H02K 7/08

(52) U.S. Cl. CPC H02K 7/003; H02K 5/06; H02K 5/1732; H02K 7/083

(57) ABSTRACT

A motor includes: an electrically conductive case; a shaft stored in the case and placed such that a part of the shaft penetrates the case; and a bearing via which the shaft is rotatably attached to the case. The shaft has an electrically conductive shaft material, and a high-resistance layer covering a surface of the shaft material and having a higher electric resistance than the shaft material.

### TECHNICAL FIELD

The present disclosure relates to an AC motor driven by an inverter.

### BACKGROUND ART

A conventional motor includes a motor case made of metal, a rotary shaft rotatably supported by the motor case via rolling bearings, a rotor fixed to the rotary shaft, and a stator opposed to the rotor and fixed to the motor case. Further, insulating parts are provided at positions adjacent to the rolling bearings, thereby making electric insulation between the motor case and the rotary shaft.

When the motor is driven by an inverter, high-frequency voltage (referred to as shaft voltage) based on a carrier frequency for operating the inverter is generated at the rotary shaft. However, since the insulating parts are provided at the positions adjacent to the rolling bearings, current (referred to as shaft current) flowing between the motor case and the rotary shaft due to generation of the shaft voltage is suppressed.

Thus, in the conventional motor, corrosion (referred to as electrolytic corrosion) occurring at the rolling bearings due to flow of the shaft current can be prevented (for example, Patent Document 1).

### CITATION LIST

### Patent Document

Patent Document 1: Japanese Laid-Open Patent Publication No. 10-75551

### SUMMARY OF THE INVENTION

### Problems to be Solved by the Invention

As described above, in the conventional motor, even when shaft voltage is generated at the rotary shaft (shaft), current flowing via the rolling bearing (bearing) is suppressed.

In general, a motive power transmission device such as a gearbox for transmitting rotational energy of a motor is connected to a shaft. Therefore, due to shaft voltage Generated at the shaft, shaft current that does not flow to the bearing may flow through the shaft to the motive power transmission device and equipment connected to the motive power transmission device.

That is, there is a possibility that shaft current flows to equipment directly and indirectly connected to the shaft and as unexpected malfunction occurs on the equipment connected to the shaft.

The present disclosure has been made to solve the problem that an unexpected malfunction occurs on equipment connected to a shaft as described above, and an object of the present disclosure is to provide a motor in which shaft current flowing from a shaft to equipment connected to the shaft is reduced.

### Solution to the Problems

A motor according to the present disclosure includes: an electrically conductive case; a rod-shaped shaft stored in the case and placed such that a part of the shaft penetrates the case; a bearing via which the shaft is rotatably attached to the case; a rotor stored in the case and fixed to the shaft; and a stator fixed to the case and placed so as to surround the rotor.

The shaft has an electrically conductive shaft material, and a high-resistance layer covering a surface of the shaft material and having a higher electric resistance than the shaft material. The shaft and the rotor are electrical insulated from each other with a first insulating material therebetween, the first insulating material having a higher electric resistance than the high-resistance layer. The shaft and the case are electrically insulated from each other with a second insulating material therebetween, the second insulating material having a higher electric resistance than the high-resistance layer.

### Effect of the Invention

The present disclosure makes it possible to provide a motor that enables suppression of an unexpected malfunction on equipment connected to a shaft.

### BRIEF DESCRIPTION OF THE DRAWINGS

FIG. 1 is a sectional view of a motor 100 according to embodiment 1.

FIG. 2 is a sectional view of a shaft 4 of the motor 100.

FIG. 3 is a connection diagram showing electric connection with a power supply device 600 when the motor 100 is driven, and mechanical connection between the shaft 4 of the motor 100 and a gearbox 400.

FIG. 4 is a sectional view of a motor 101 according to embodiment 2.

FIG. 5 is a sectional view of a motor 102 according to embodiment 3.

FIG. 6 is a sectional view of a motor 103 according to embodiment 4.

FIG. 7 is a sectional view of a motor 104 according to embodiment 5.

FIG. 8 is a sectional view of a motor 105 according to embodiment 6.

FIG. 9 is a sectional view of a shaft 4E of the motor 105.

FIG. 10 is a sectional view of a motor 106 according to embodiment 7.

FIG. 11 is a sectional view of a shaft 4F of the motor 106 and a surrounding part thereof.

### DESCRIPTION OF EMBODIMENTS

### Embodiment 1

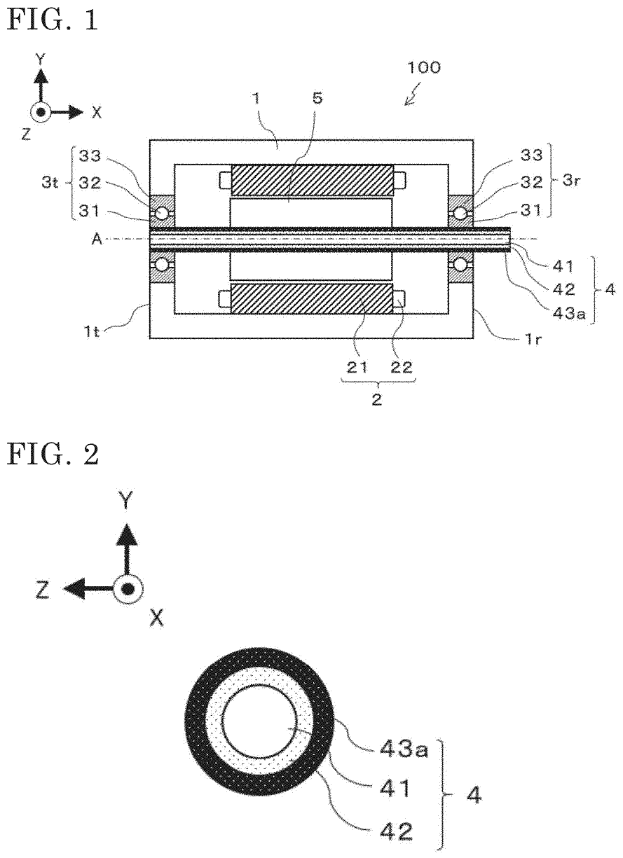

Hereinafter, embodiment 1 of the present disclosure will be described in detail, with reference to FIG. 1 to FIG. 3.

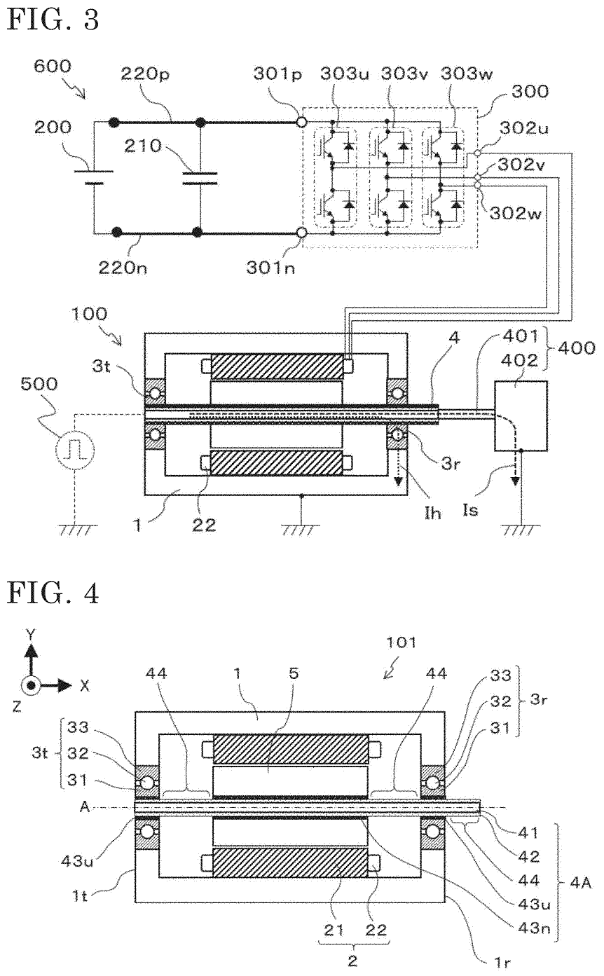

First, with reference to FIG. 1 and FIG. 2, the configuration of a motor 100 according to embodiment 1 will be described, and then, with reference to FIG. 3, operations and effects of the motor 100 will be described.

With reference to FIG. 1 and FIG. 2, the structure of the motor 100 according to embodiment 1 will be described.

FIG. 1 is a sectional view of the motor 100 according to embodiment 1 for carrying out the present disclosure, and FIG. 2 is a sectional view of a shaft 4 which is a component of the motor 100.

FIG. 1 and FIG. 2 are schematic views and do not indicate exact dimensions of parts. For example, in FIG. 2, the ratios between the diameter of a shaft material 41 of the shaft 4, and the thickness of a high-resistance layer 42 and the thickness of an insulating layer 43a thereof, are not exactly shown. The diameter of the shaft material 41, the thickness of the high-resistance layer 42, and the thickness of the insulating layer 43a of the shaft 4 are determined as appropriate in accordance with the specifications of the motor 100.

In FIG. 1 and FIG. 2, the motor 100 includes a case 1, a rod-shaped shaft 4 stored in the case 1 and placed such that a part of the shaft 4 penetrates the case 1, and bearings 3 via which the shaft 4 is rotatably attached to the case 1. In addition, the motor 100 includes a rotor 5 stored in the case 1 and fixed to the shaft 4, and a stator 2 fixed to the case 1 and placed so as to surround the rotor 5. The bearings 3 refer to a bearing 3r and a bearing 3t described later, collectively.

Further, the shaft 4 has the high-resistance layer 42 covering the surface of the shaft material 41, and further has the insulating layer 43a covering the surface of the high-resistance layer 42. Further, the high-resistance layer 42 has a higher electric resistance than the shaft material 41, and the insulating layer 43a has a higher electric resistance than the high-resistance layer 42.

The insulating layer 43a is an example of a first insulating material and a second insulating material, and serves as both the first insulating material and the second insulating material.

In FIG. 1, an X direction coincides with a direction from the left to the right on the drawing sheet, a Y direction coincides with a direction from the lower side to the upper side on the drawing sheet of FIG. 1, and a Z direction coincides with a direction from the back side to the front side of the drawing sheet of FIG. 1.

In addition, the X direction, the Y direction, and the Z direction in FIG. 2 coincide with the X direction, the Y direction, and the Z direction in FIG. 1, respectively.

The case 1 is made of an electrically conductive member such as an iron-steel material (e.g., carbon steel such as S45C) or alloy steel (e.g., stainless steel). The shaft 4 is stored inside the case 1 and is rotatably supported by the bearing 3r provided at an X-direction side wall portion it which is a wall surface on the X-direction side of the case 1 and the bearing 3t provided at an opposite X-direction. side wall portion 1t which is a wall surface on the opposite X-direction side of the case 1. A part on the X-direction side of the shaft 4 penetrates the case 1. An axis A shown by a dotted-dashed line represents the center axis of the shaft 4, and the direction of the axis A coincides with the X direction.

Each bearing 3 is composed of an annular inner ring 31 connected to the shaft 4, an annular outer ring 33 connected to the case 1, and a plurality of spherical bails 32 provided between the inner ring 31 and the outer ring 33.

Further, in order to reduce the frictional resistance between the inner ring 31 and the outer ring 33, grease (not shown) may be applied to the surfaces of the balls 32.

The rotor 5 formed by permanent magnets is attached to the shaft 4. The permanent magnets form at least one pair of magnetic poles with the shaft 4 therebetween.

On the inner side of the case 1, the stator 2 is attached, and the stator 2 is placed so as to surround the rotor 5. The stator 2 is composed of a core 21 made of a magnetic material, and a winding 22 wound around the core 21.

As described above, the shaft 4 has the electrically conductive shaft material 41 and the high-resistance layer 42 covering the surface of the shaft material 41 and having a higher electric resistance than the shaft material 41, and further has the insulating layer 43a which has insulating property and which covers the surface of the high-resistance layer 42 and has a higher electric resistance than the high-resistance layer 42.

The volume resistivity of the shaft material 41 is desirably 10 μΩ·cm to 60 μΩ·cm, the volume resistivity of the high-resistance layer 42 is desirably 60 μΩ·cm to 200 μΩ·cm, and. the volume resistivity of the insulating layer 43a is desirably 10⁸ Ω·cm or higher.

The volume resistivity of the shaft material 41 is more desirably 10 μΩ·cm to 20 μΩ·cm, the volume resistivity of the high-resistance layer 42 is more desirably 150 μΩ·cm to 200 μΩ·cm, and the volume resistivity of the insulating layer 43a is more desirably 10¹⁴ Ω·cm or higher.

In general, as the material of the shaft material 41 of the shaft 4, metal is used, and in particular, an iron-steel material or the like is used. Examples of the material of the high-resistance layer 42 include a nickel (Ni) film containing phosphorus (P), and it is possible to set the specific resistance value of the high-resistance layer 42 by adjusting the content of phosphorus. As the manufacturing method therefor, plating or the like may be used.

Examples of the material of the insulating layer 43a include films of aluminium oxides (Al₂O₃, AlO, and Al₂O). As the manufacturing method therefor, for example, an aluminum (Al) film is deposited on the surface of the high-resistance layer 42 by vapor deposition or the like, and then is heated in an atmosphere containing oxygen (O₂), to oxidize the aluminum film, thus forming an aluminium oxide.

In a case of driving the motor 100 by three-phase AC voltages, the winding 22 is composed of three winding portions that are a u-phase winding portion, a v-phase winding portion, and a w-phase winding portion. One end of the u-phase winding portion is connected to the u phase of the three-phase AC voltages, one end of the v-phase winding portion is connected to the v phase of the three-phase AC voltages, and one end of the w-phase winding portion is connected to the w phase of the three-phase AC voltages. Another end of the u-phase winding portion, another end of the w-phase winding portion, and another end of the w-phase winding portion are connected to each other. That is, the winding 22 forms star connection (not shown).

The u-phase winding portion, the v-phase winding portion, and the w-phase winding portion are wound at predetermined positions of the core 21 part (not shown).

Next, operations and effects of the motor 100 will be described.

FIG. 3 shows electric connection with a power supply device 600 when the motor 100 is driven, and mechanical connection between the shaft 4 of the motor 100 and a gearbox 400. Further, paths of shaft currents are shown in FIG. 3.

First, electric connection with the power supply device 600 for driving the motor 100 will be described.

The power supply device 600 is composed of a battery 200, a smoothing capacitor 210, a positive DC bus 220p, a negative DC bus 220n, and an inverter circuit 300.

A positive input terminal 301p of the inverter circuit 300 is connected to one end of the positive DC bus 220p, and a negative input terminal 301n of the inverter circuit 300 is connected to one end of the negative DC bus 220n. Another end of the positive DC bus 220p is connected to a positive terminal of the battery 200, and another end of the negative DC bus 220n is connected to a negative terminal of the battery 200.

One end of the smoothing capacitor 210 is connected to the positive DC bus 220p, and another end of the smoothing capacitor 210 is connected to the negative DC bus 220n.

The battery 200 supplies DC power to the inverter circuit 300, and the smoothing capacitor 210 serves to stabilize DC voltage between the positive DC bus 220p and the negative DC bus 220n.

The inverter circuit 300 has three output terminals that are a u-phase output terminal 302u, a v-phase output terminal 302v, and a w-phase output terminal 302w, for outputting three-phase AC voltages. The u-phase output terminal 302u is a terminal for outputting u-phase voltage of the three-phase AC voltages, the v-phase output terminal 302v is a terminal for outputting v-phase voltage of the three-phase AC voltages, and the w-phase output terminal 302w is a terminal for outputting w-phase voltage of the three-phase AC voltages.

The u-phase output terminal 302u is electrically connected to the one end of the u-phase winding portion of the winding 22, the v-phase output terminal 302v is electrically connected to the one end of the v-phase winding portion of the winding 22, and the w-phase output terminal 302w is electrically connected to the one end of the w-phase winding portion of the winding 22.

The inverter circuit 300 has three legs that are a leg 303u, a leg 303v, and a leg 303w. A structure is which a diode and an insulated gate bipolar transistor (IGBT) are connected in antiparallel to each other is referred to as an arm, and a structure in which two arms (upper arm and lower arm) are electrically connected in series to each other is referred to as a leg.

The details of electric connection of one leg is as follows. Of the two arms, the collector terminal side of the IGBT of the upper arm is electrically connected to the positive input terminal 301p, and the emitter terminal side of the IGBT of the lower arm is electrically connected to the negative input terminal 301n. The emitter terminal side of the IGBT of the upper arm and the collector terminal side of the IGBT of the lower arm are electrically connected to any of the output terminals.

The leg 303u is connected to the u-phase output terminal 302u, the leg 303v is connected to the v-phase output terminal 320v, and the leg 303w is connected to the w-phase output terminal 302w.

A control circuit (not shown) is connected to gate electrodes of six IGBTs of the leg 303u, the leg 303v, and the leg 303w.

Next, mechanical connection between the motor 100 and the gearbox 400 will be described.

The shaft 4 of the motor 100 is connected to a shaft 401 of the gearbox 400. The gearbox 400 is, for example, a transmission, and is composed of the shaft 401 and a gearbox body 402. Rotation of the shaft 401 is changed in speed by gears inside the gearbox body 402, and the resultant rotational energy is transmitted to another device connected to the gearbox 400 (not shown).

Further, operations of the motor 100, paths of shaft currents, and effects of the present disclosure will be described.

The control circuit applies pulse voltages to the gate electrodes of the six IGBTs of the leg 303u, the leg 303v, and the leg 303w on the basis of a motor operation command value through a pulse width modulation (PWM) control method, to execute ON/OFF operations of the IGBTs. The three-phase AC voltages having an amplitude and a frequency corresponding to the above operations are outputted from the u-phase output terminal 302u, the v-phase output terminal 302v, and the w-phase output terminal 302w.

That is, DC power supplied from the battery 200 to the inverter circuit 300 is converted to AC power by the inverter circuit 300. Then, the AC power is supplied to the motor 100, thereby rotating the shaft 4 of the motor 100.

A generation mechanism of shaft voltage and shaft current (Ih, Is) will be described.

A carrier frequency used in the PWM control method is higher than the frequency of the three-phase AC voltages. Therefore, pulse voltage due to the carrier frequency is superimposed on AC voltage outputted from the inverter circuit 300. That is, the pulse voltage based on the carrier frequency is superimposed on the winding 22. Further, since the winding 22 and the shaft material 41 of the shaft 4 are coupled with each other by an electric capacitance, the pulse voltage due to the carrier frequency is superimposed thereon, thus generating shaft voltage.

A virtual pulse power source 500 in FIG. 3 is a virtually assumed pulse power source which does not actually exist, and is assumed as a source that generates shaft voltage. One end of the virtual pulse power source 500 is electrically connected to the shaft material 41 of the shaft 4, and another end of the virtual pulse power source 500 is grounded.

Shaft current Ih is shaft current that is generated due to the shaft voltage generated at the shaft material 41 of the shaft 4 and flows from the shaft material 41 to the case 1 through the bearing 3r or the bearing 3t.

Shaft current Is is shaft current that is generated due to the shaft voltage generated at the shaft material 41 of the shaft 4 and flows from the shaft material 41 to the gearbox body of the gearbox 400 through the shaft 401 of the gearbox 400. Further, the shaft current Is includes shaft current flowing from the gearbox 400 to another device connected to the gearbox 400.

Next, effects of reducing the shaft current Ih and the shaft current Is according to embodiment 1 will be described.

First, the effect of reducing the shaft current Ih will be described.

As described above, the shaft material 41 of the shaft 4 is covered by the high-resistance layer 42, the high-resistance layer 42 is further covered by the insulating layer 43a, and the bearing 3r and the bearing 3t are provided on the insulating layer 43a. That is, the current amount of the shaft current Ih flowing from the shaft material 41 to the case 1 through the bearing 3r or the bearing 3t is almost zero amperes. Thus, corrosion of the bearings 3 due to flow of the shaft current Ih can be prevented.

Next, the effect of reducing the shaft current Is will be described.

As described above, the shaft voltage is pulse voltage, and therefore the shaft current is also pulse current. The pulse current is current in which AC currents having different frequencies are superimposed. Therefore, for each AC current, a skin effect according to the frequency is exhibited.

In general, the skin effect is a phenomenon in which, when AC current flows in a conductor, the current density is higher at the conductor surface and becomes lower as becoming farther from the surface. The higher the frequency is, the more the current concentrates at the surface.

That is, with the shaft current Is subject to the skin effect, the current density of the shaft current Is becomes higher from the center of the shaft 4 toward the circumferential side. Therefore, if setting is made such that the current density of the shaft current. Is becomes high in the high-resistance layer 42, the shaft current Is is attenuated by a comparatively high resistance component of the high-resistance layer 42, so that flow of the shaft current Is to the gearbox 400 is suppressed and an unexpected malfunction does not occur. The electric energy of the shaft current Is is converted to thermal energy by the high-resistance layer 42, thus being released into the air.

Further, with the insulating layer 43a provided between the rotor 5 and the shaft material 41, the rotor 5 and the shaft material 41 are electrically insulated from each other, and the rotor 5 and the shaft material 41 are coupled with each other by an electric capacitance therebetween. That is, the electric capacitance is present in series between the winding 22 and the shaft material 41, so that the electric capacitance between the winding 22 and the shaft material 41 is reduced, thus providing effects of reducing the shaft current Ih and the shaft current Is.

According to embodiment 1, as described above, by reducing the shaft current Ih, corrosion of the bearings 3 is suppressed and failure of the motor 100 is prevented, and by reducing the shaft current Is, occurrence of an unexpected malfunction on equipment connected to the shaft 4 is suppressed.

That is, according to embodiment 1, it is possible to provide the motor 100 that is highly reliable and does not cause an unexpected malfunction on other connected equipment.

### Embodiment 2

In embodiment 1, it has been described that the shaft 4 has the high-resistance layer 42 covering the surface of the shaft material 41, and further, the insulating layer 43a covering the surface of the high-resistance layer 42, and that the high-resistance layer 42 has a higher electric resistance than the shaft material 41 and the insulating layer 43a has a higher electric resistance than the high-resistance layer 42. Further, it has been described that shaft current generated at the shaft 4 flows to the high-resistance layer 42 by the skin effect, and the electric energy of the shaft current Is is converted to thermal energy.

In embodiment 2, a case of having a structure in which a part of the high-resistance layer 42 covering the surface of the shaft material 41 is not covered by the insulating layer 43a so that the part of the high-resistance layer 42 is exposed, will be described.

FIG. 4 is a sectional view of a motor 101 according to embodiment 2 for carrying out the present disclosure.

In FIG. 4, the same reference characters as in FIG. 1 and FIG. 2 denote components that are the same as or equivalent to those shown in embodiment 1, and therefore the detailed description thereof is omitted.

Also, driving of the motor 101 is the same as in embodiment 1, and therefore the detailed description thereof is omitted.

With reference to FIG. 4, the structure of the motor 101 will be described.

The structures of the motor 101 and the motor 100 are different in the structures of a shaft 4A and the shaft 4.

The shaft 4A has, on the surface of the high-resistance layer 42 between the shaft material 41 and each bearing 3, an insulating layer 43u having a higher electric resistance than the high-resistance layer 42. With this structure, electric insulation between the shaft 4A and the case 1 is maintained.

In addition, the shaft 4A has, on the surface of the high-resistance layer 42 between the shaft material 41 and the rotor 5, an insulating layer 43n having a higher electric resistance than the high-resistance layer 42. With this structure, electric insulation between the shaft 4A and the rotor 5 is maintained. When the insulating layer 43n and the insulating layer 43u are collectively mentioned, they are referred to as insulating layers 43.

The insulating layer 43n is an example of a first insulating material and the insulating layer 43u is an example of a second insulating material.

Further, the shaft 4A has high-resistance-layer exposed portions 44 where the surface of the high-resistance layer 42 is exposed. The high-resistance-layer exposed portions 44 are provided at the following three locations.

The first location where the high-resistance-layer exposed portion 44 is provided is a position on the X-direction side from the position where the bearing 3r is connected to the shaft 4A. The second location where the high-resistance-layer exposed portion 44 is provided is a position that is on the X-direction side from the position where the rotor 5 is connected to the shaft 4A and on the opposite X-direction side from the position where the bearing 3r is connected to the shaft 4A. The third location where the high-resistance-layer exposed portion 44 is provided is a position that is on the X-direction side from the position where the bearing 3t is connected to the shaft 4A and on the opposite X-direction side from the position where the rotor 5 is connected to the shaft 4A.

Next, effects of embodiment 2 will be described.

In a case where the surface of the high-resistance layer 42 is covered by the insulating layer 43, heat generated in the high-resistance layer 42 conducts to the insulating layer 43 and then is dissipated from the surface of the insulating layer 43. In general, the thermal conductivity of the insulating layer 43 is lower than that of the high-resistance layer 42 or the shaft material 41. Therefore, heat dissipation performance in this case depends on the thermal conductivity of the insulating layer 43.

On the other hand, in embodiment 2, since the shaft 4A has the high-resistance-layer exposed portions 44 where the surface of the high-resistance layer 42 is exposed, heat generated in the high-resistance layer 42 is efficiently dissipated from the high-resistance-layer exposed portions 44. That is, heat flowing into parts of the motor 101 such as the shaft 4A and the bearings 3 can be reduced.

As described above, the insulating layers 43 are provided between the bearing 3r and the shaft material 41, between the rotor 5 and the shaft material 41, and between the bearing 3t and the shaft material 41. That is, as in embodiment 1, the shaft current Ih is suppressed and corrosion of the bearings 3 due to flow of the shaft current Ih can be prevented.

Further, as in embodiment 1, since the high-resistance layer 42 covering the surface of the shaft material 41 is provided to the shaft 4A, the shaft current Is can be reduced and the electric energy can be efficiently converted to heat.

According to embodiment 2, as in embodiment 1, by reducing the shaft current Ih, corrosion of the bearings 3 is suppressed and failure of the motor 101 is prevented, and by reducing the shaft current Is, occurrence of an unexpected malfunction of equipment connected to the shaft 4A is suppressed.

Further, heat generated due to the shaft current can be efficiently dissipated from the high-resistance-layer exposed portions 44, whereby heat flowing into parts of the motor 101 such as the shaft 4A and the bearings 3 can be reduced.

That is, according to embodiment 2, it is possible to provide the motor 101 that is highly reliable and does not cause an unexpected malfunction on other connected equipment.

In embodiment 2, it has been described that the high-resistance-layer exposed portions 44 are provided at the above-described three locations. However, the positions where the high-resistance-layer exposed portions 44 are provided are determined by the specifications of the motor 101 and are not limited to the above-described positions.

### Embodiment 3

In embodiment 2, it has been described that the insulating layer 43u is provided between each bearing 3 and the shaft material 41, and electric insulation between each bearing 3 and the shaft material 41 is maintained.

In embodiment 3, a case where bearings 3A made of an electrically insulating material are provided instead of electrically conductive bearings 3 will be described. The bearings 3A refer to a bearing 3At and a bearing 3Ar described later, collectively.

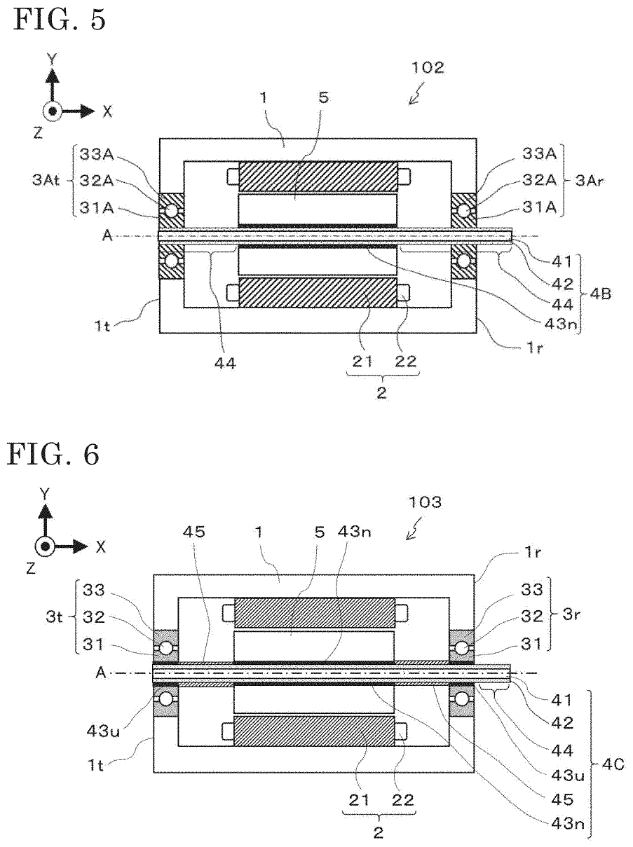

FIG. 5 is a sectional view of a motor 102 according to embodiment 3 for carrying cut the present disclosure.

In FIG. 5, the same reference characters as in FIG. 4 denote components that are the same as or equivalent to those shown in embodiment 2, and therefore the detailed description thereof is omitted.

Also, driving of the motor 102 is the same as in embodiment 1, and therefore the detailed description thereof is omitted.

The insulating layer 43n is an example of a first insulating material and the bearing 3A is an example of a second insulating material.

With reference to FIG. 5, the structure of the motor 102 will be described.

The structures of the motor 102 and the motor 101 are different in the structure of a shaft 4B and the shaft 4A and the structures of the bearing 3A and the bearing 3.

Each bearing 3A has electrically insulating property. At least one of an inner ring 311, balls 32A, and an outer ring 33A which are components of the bearing 3A is made of an insulating member. This insulating member is ceramic, resin, or the like.

Unlike the structure of the shaft 4A, the shaft 4B does not have the insulating layer 43u on the surface of the high-resistance layer 42 between the shaft material 41 and each bearing 3A. In other words, on the shaft 4B, the high-resistance-layer exposed portions 44 where the surface of the high-resistance layer 42 is exposed are provided at the following two locations.

The first location where the high-resistance-layer exposed portion 44 is provided is a position on the X-direction side from the position where the rotor 5 is connected to the shaft 4B, and includes a position where the bearing 3Ar is connected to the shaft 4B. The second location where the high-resistance-layer exposed portion 44 is provided is a position on the opposite X-direction side from the position where the rotor 5 is connected to the shaft 4B, and includes the position where the bearing 3At is connected to the shaft 4B.

Next, effects of the embodiment 3 will be described.

As described above, each bearing 3A has electrically insulating property, and therefore electric insulation between the shaft 4B and the case 1 is maintained. That is, as embodiment 2, the shaft current Ih is suppressed and corrosion of the bearing 3Ar and the bearing 3At due to flow of the shaft current Ih can be prevented.

Further, as in embodiment 2, since the high-resistance layer 42 covering the surface of the shaft material 41 is provided to the shaft 4B, the shaft current Is can be reduced and the electric energy can be efficiently converted to heat. In addition, since the high-resistance-layer exposed portions 44 are provided, heat generated due to the shaft current can be efficiently dissipated, whereby heat flowing into parts of the motor 102 such as the shaft 4B and the bearings 3A can be reduced.

That is, according to embodiment 3, as in embodiment 1, by reducing the shaft current Ih, corrosion of the bearing 3A is suppressed and failure of the motor 102 is prevented, and by reducing the shaft current Is, occurrence of an unexpected malfunction of equipment connected to the shaft 4B is suppressed.

Further, heat Generated due to the shaft current Is can be efficiently dissipated from the high-resistance-layer exposed portions 44, whereby heat flowing into parts of the motor 102 such as the shaft 4B and the bearings 3A can be reduced.

That is, according to embodiment 3, it is possible to provide the motor 102 that is highly reliable and does not cause an unexpected malfunction on other connected equipment.

In embodiment 3, it has been described that the high-resistance-layer exposed portions 44 are provided at the above-described two locations. However, the positions where the high-resistance-layer exposed portions 44 are provided are determined by the specifications of the motor 102 and are not limited to the above-described positions.

### Embodiment 4

In embodiment 2, it has been described that the shaft 4A has the high-resistance-layer exposed portions 44 where the surface of the high-resistance layer 42 is exposed, whereby heat generated due to the shaft current Is can be efficiently dissipated.

In embodiment 4, a case where high-thermal-conductivity layers 45 made of a member having a higher thermal conductivity than the high-resistance layer 42 are provided on the surface of the high-resistance layer 42 covering the surface of the shaft material 41, will be described.

FIG. 6 is a sectional view of a motor 103 according to embodiment 4 for carrying out the present disclosure.

In FIG. 6, the same reference characters as in FIG. 4 denote components that are the same as or equivalent to those shown in embodiment 2, and therefore the detailed description the is omitted.

Also, driving of the motor 103 is the same as in embodiment 1, and therefore the detailed description thereof is omitted.

With reference to FIG. 6, the structure of the motor 103 will be described.

The structures of the motor 103 and the motor 101 are different mainly in the structures of a shaft 4C and the shaft 4A.

As with the shaft 4A, the shaft 4C has the electrically conductive shaft material 41 and the high-resistance layer 42 covering the surface of the shaft material 41, and the high-resistance layer 42 has a higher electric resistance than the shaft material 41.

Further, the shaft 4C has, on the surface of the high-resistance layer 42 between the shaft material 41 and each bearing 3, the insulating layer 43u. having a higher electric resistance than the high-resistance layer 42, and electric insulation between the shaft 4C and the case 1 is maintained.

In addition, as with the shaft 4A, the shaft 4C has, on the surface of the high-resistance layer 42 between the shaft material 41 and the rotor 5, the insulating layer 43n having a higher electric resistance than the high-resistance layer 42, and electric insulation between the shaft 4A and the rotor 5 is maintained.

Further, the shaft 4C has, on the surface of the high-resistance layer 42, the high-thermal-conductivity layers 45 made of a member having a higher thermal conductivity than the high-resistance layer 42. The high-thermal-conductivity layers 45 are provided at the following two locations.

The first location where the high-thermal-conductivity layer 45 is provided is a surface of the high-resistance layer 42 that is on the X-direction side from the position where the rotor 5 is connected to the shaft 4C and on the opposite X-direction side from the position where the bearing 3r is connected to the shaft 4C. The second location where the high-thermal-conductivity layer 45 is provided is a surface of the high-resistance layer 42 of the shaft 4C that is on the X-direction side from the position where the bearing 3t is connected to the shaft 4A and on the opposite X-direction side from the position where the rotor 5 is connected to the shaft 4A.

Next, effects of embodiment 4 will be described.

Since the shaft 4C has the high-thermal-conductivity layers 45 on the surface of the high-resistance layer 42, heat generated in the high-resistance layer 42 efficiently transfers to the high-thermal-conductivity layers 45, and further, is efficiently dissipated from the surfaces of the high-thermal-conductivity layers 45 into the air.

In addition, as described above, the insulating layers 43 are provided between the bearing 3r and the shaft material 41, between the rotor 5 and the shaft material 41, and between the bearing 3t and the shaft material 41. That is, as in embodiment 1, the shaft current Ih is suppressed. and corrosion of the bearing 3r and the bearing 3t due to flow of the shaft current Ih can be prevented.

Further, as in embodiment 1, since the high-resistance layer 42 covering the surface of the shaft material 41 is provided to the shaft 4C, the shaft current Is can be reduced and the electric energy can be efficiently converted to heat.

In addition, since the high-thermal-conductivity layers 45 are provided to the shaft 4C, heat generated due to the shaft current Is can be efficiently dissipated, whereby heat flowing into parts of the motor 103 such as the shaft 4C and the bearings 3 can be reduced.

In a case where an iron-steel material or the like is used for the shaft material 41, for example, a film of aluminum (Al) having a higher thermal conductivity than stainless steel, or the like, can be used as the material of the high-thermal-conductivity layer 45.

That is, according to embodiment 4, as in embodiment 1, by reducing the shaft current Ih, corrosion of the bearings 3 is suppressed and failure of the motor 103 is prevented, and by reducing the shaft current Is, occurrence of an unexpected malfunction of equipment connected to the shaft 4C is suppressed.

Further, heat generated due to the shaft current can be efficiently dissipated from the high-thermal-conductivity layers 45, whereby heat flowing into parts of the motor 103 such as the shaft 4C and the bearings 3 can be reduced.

Thus, according to embodiment 4, it is possible to provide the motor 103 that is highly reliable and does not cause an unexpected malfunction on other connected equipment.

In embodiment 4, it has been described that the high-thermal-conductivity layers 45 are provided at the above-described two locations. However, the positions where the high-thermal-conductivity layers 45 are provided are determined by the specifications of the motor 103 and are not limited to the above-described positions.

### Embodiment 5

In embodiment 2, it has been described that the shaft 4A has the high-resistance-layer exposed portions 44 where the surface of the high-resistance layer 42 is exposed, whereby the motor 101 allows heat generated due to the shaft current Is to be efficiently dissipated.

In embodiment 5, a case where a shaft 4D has fins 46 at a shaft material 41a will be described.

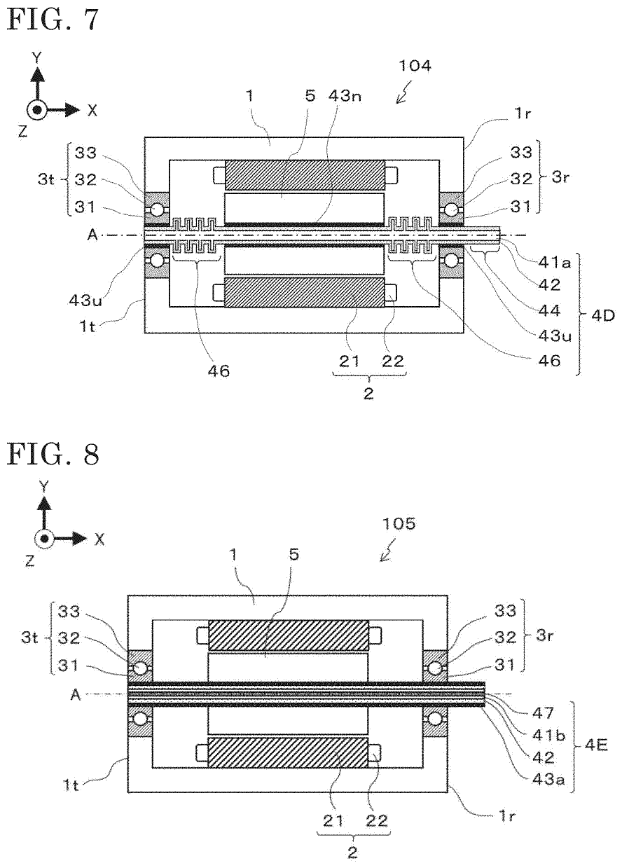

FIG. 7 is a sectional view of a motor 104 according to embodiment 5 for carrying out the present disclosure.

In FIG. 7, the same reference characters as in FIG. 4 denote components that are the same as or equivalent to those shown in embodiment 2, and therefore the detailed description thereof is omitted.

Also, driving of the motor 104 is the same as in embodiment 1, and therefore the detailed description thereof is omitted.

With reference to FIG. 7, the structure of the motor 104 will be described.

The structures of the motor 104 and the motor 101 are different mainly in the structures of the shaft 4D and the shaft 4A.

The shaft 4D has the heat dissipation fins 46. The fins 46 are plate members and are attached to the surface of the shaft material 41a such that one side of each plate member is directed in a direction perpendicular to the X direction from the axis A.

As with the shaft 4A, the shaft 4D has, on the surface of the electrically conductive shaft material 41a and the surfaces of the fins 46, the high-resistance layer 42 having a higher electric resistance than the shaft material 41a.

Further, the shaft 4D has, on the surface of the high-resistance layer 42 between the shaft material 41a and each bearing 3, the insulating layer 43u having a higher electric resistance than the high-resistance layer 42, and electric insulation between the shaft 4D and the case 1 is maintained.

In addition, as with the shaft 4A, the shaft 4D has, on the surface of the high-resistance layer 42 between the shaft material 41 and the rotor 5, the insulating layer 43n having a higher electric resistance than the high-resistance layer 42, and electric insulation between the shaft 4A and the rotor 5 is maintained.

Next, effects of embodiment 5 will be described.

Since the fins 46 are provided on the surface of the shaft material 41a, the shaft 4D has an increased area contacting with the air, as compared to the shaft 4A. Therefore, during operation of the motor 104, heat generated in the high-resistance layer 42 transfers to the fins 46, and further, is efficiently dissipated from the surfaces of the fins 46 into the air.

In addition, as described above, the insulating layer 43u is provided between each bearing 3 and the shaft material 41, and the insulating layer 43n is provided between the rotor 5 and the shaft material 41a. Thus, as in embodiment 1, the shaft current Ih is suppressed and corrosion of the bearing 3r and the bearing 3t due to flow of the shaft current Ih can be prevented.

Further, as in embodiment 1, since the high-resistance layer 42 covering the surface of the shaft material 41 is provided to the shaft 4D, the shaft current Is can be reduced and the electric energy can be efficiently converted to heat.

In addition, since the fins 46 are provided to the shaft 4D, heat generated due to the shaft current Is can be efficiently dissipated, whereby heat flowing into parts of the motor 104 such as the shaft 4D and the bearings 3 can be reduced.

That is, according to embodiment 5, as in embodiment 1, by reducing the shaft current Ih, corrosion of the bearings 3 is suppressed and failure of the motor 104 is prevented, and by reducing the shaft current Is, occurrence of an unexpected malfunction of equipment connected to the shaft 4C is suppressed.

Further, heat generated due to the shaft current can be efficiently dissipated from the fins 46, whereby heat flowing into parts of the motor 104 such as the shaft 4D and the bearings 3 can be reduced.

Thus, according to embodiment 5, it is possible to provide the motor 104 that is highly reliable and does not cause an unexpected malfunction on other connected equipment.

In embodiment 5, it has been described that the fins 46 are provided at the above-described locations. However, the positions where the fins 46 are provided are determined by the specifications of the motor 104 and are not limited to the above-described locations.

In embodiment 5, it has been described that the fins 46 are plate members and are attached to the surface of the shaft material 41a. However, the fins 46 may be attached on the surface of the high-resistance layer 42. In addition, the order and the method for attaching the fins 46 are determined by the specifications of the motor 104, and are not limited to the above-described order and method.

In embodiment 5, it has been described that the fins 46 are provided such that one side of each plate member is directed in the direction perpendicular to the X direction from. the axis A. However, the fins 46 may not necessarily be plate members, and may not necessarily be provided in the direction perpendicular to the X direction. The shape and the attachment direction of the fins 46 are determined by the specifications of the motor 104, and are not limited to the above-described shape and attachment direction of the fins 46.

### Embodiment 6

In embodiment 5, it has been described that the fins 46 are provided to the shaft 4D and the motor 104 allows heat generated due to the shaft current to be efficiently dissipated.

In embodiment 6, a case where a shaft 4E has, in a shaft material 41b, a flow path 47 through which a coolant flows will be described.

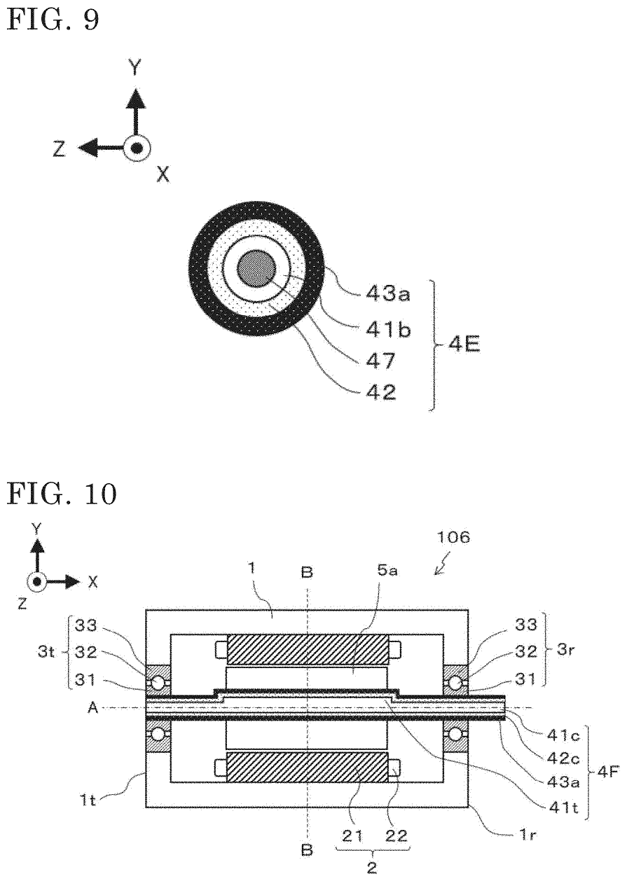

FIG. 8 is a sectional view of a motor 105 according to embodiment 6 for carrying out the present disclosure, and FIG. 9 is a sectional view of the shaft 4E which is a component of the motor 105. In FIG. 8 and FIG. 9, the same reference characters as in FIG. 1 and FIG. 2 denote components that are the same as or equivalent to those shown in embodiment 1, and therefore the detailed description thereof is omitted.

Also, driving of the motor 105 is the same as in embodiment 1, and therefore the detailed description thereof is omitted.

With reference to FIG. 8 and FIG. 9, the structure of the motor 105 will be described.

The structures of the motor 105 and the motor 100 are different mainly in the structures of the shaft 4E and the shaft 4.

The shaft 4E has, in the shaft material 41b, the flow path 47 through which a coolant flows. The flow path 47 is a hole formed along the axis A in the shaft material 41b, and during operation of the motor 105, a coolant (not shown) described later flows through the inside of the flow path 47. In other words, the shaft material 41b serves as a pipe that allows the coolant to flow therethrough. Examples of the coolant include water, oil, and dry air.

Next, effects of embodiment 6 will be described.

During operation of the motor 105, the coolant is caused to flow through the shaft 4E. In this case, heat generated in the high-resistance layer 42 transfers to the shaft material 41b, and then transfers from the shaft material 41b to the flowing coolant. From the coolant, the heat passes through a heat exchanger (not shown), to be efficiently dissipated into the air.

The insulating layer 43a is provided between each bearing 3 and the shaft material 41b, and between the rotor 5 and the shaft material 41b. Thus, as in embodiment 1, the shaft current Ih is suppressed and corrosion of the bearing 3r and the bearing 3t due to flow of the shaft current Ih can be prevented.

In addition, as in embodiment 1, since the high-resistance layer 42 covering the surface of the shaft material 41b is provided to the shaft 4E, the shaft current Is can be reduced and the electric energy can be efficiently converted to heat.

Further, since the flow path 47 is provided to the shaft 4E, heat generated due to the shaft current Is can be efficiently dissipated, whereby heat flowing into parts of the motor 105 such as the shaft 4E and the bearings 3 can be reduced.

That is, according to embodiment 6, as in embodiment 1, by reducing the shaft current Ih, corrosion of the bearings 3 is suppressed and failure of the motor 105 is prevented, and by reducing the shaft current Is, occurrence of an unexpected malfunction of equipment connected to the shaft 4E is suppressed.

Further, heat generated due to the shaft current Is can be efficiently dissipated, whereby heat flowing into parts of the motor 105 such as the shaft 4E and the bearings 3 can be reduced.

Thus, according to embodiment 6, it is possible to provide the motor 105 that is highly reliable and does not cause an unexpected malfunction on other connected equipment.

### Embodiment 7

In embodiment 7, a case where a shaft 4F has a protrusion 41t, a rotor 5a has a recess 5u, and the protrusion 41t and the recess 5u are fitted to each other, whereby the shaft 4F and the rotor 5a are firmly joined to each other, will be described.

FIG. 10 is a sectional view of a motor 106 according to embodiment 7 for carrying out the present disclosure, and 11 is a sectional view of the shaft 4E and the rotor 5a along a broken line B-B in FIG. 10, as seen from the opposite X-direction.

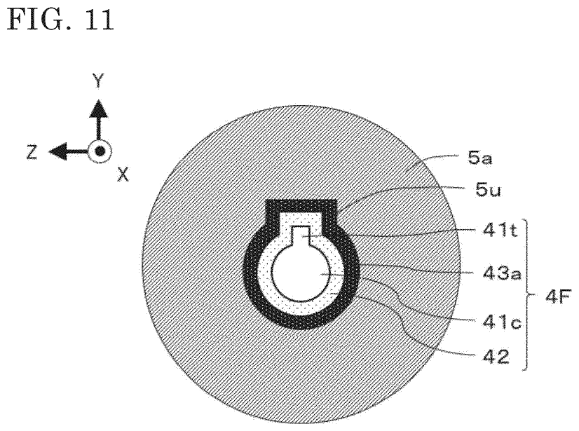

In FIG. 10 and FIG. 11, the same reference characters as in FIG. 1 and FIG. 2 denote components that are the same as or equivalent to those shown in embodiment 1, and therefore the detailed description thereof is omitted.

Also, driving of the motor 106 is the same as in embodiment 1, and therefore the detailed description thereof is omitted.

With reference to FIG. 10 and FIG. 11, the structure of the motor 106 will be described.

The structures of the motor 106 and the motor 100 are different mainly in the structures of the shaft 4F and the shaft 4 and the structures of the rotor 5 and the rotor 5a.

The shaft 4F has the protrusion 41t having a shape protruding in a direction perpendicular to the X direction, at a part of the shaft material 41c. In addition, as with the shaft 4, the shaft 4F has the high-resistance layer 42 on the surface of the shaft material 41c, and further has the insulating layer 43a on the surface of the high-resistance layer 42.

On the other hand, the rotor 5a has the recess 5u having a shape partially recessed at a surface thereof contacting with the shaft 4F.

As described above, the motor 106 has a structure in which the protrusion 41t of the shaft 4F and the recess 5u of the rotor 5a are fitted to each other, whereby the shaft 4F and the rotor 5a are firmly joined to each other.

Next, effects of embodiment 7 will be described.

Even when the shaft 4F and the rotor 5a are rotating during operation of the motor 106, since the protrusion 41t and the recess 5u are fitted to each other and the shaft 4F and the rotor 5a are firmly joined to each other, the shaft 4F and the rotor 5a less rub against each other.

Thus, wear of the high-resistance layer 42 and the insulating layer 43a due to the shaft 4F and the rotor 5a rubbing against each other can be prevented. That is, the functions of the high-resistance layer 42 and the insulating layer 43a can be maintained for a long period.

As described above, the insulating layer 43a is provided between each bearing 3 and the shaft material 41, and between the rotor 5 and the shaft material 41a. That is, as in embodiment 1, the shaft current Ih is suppressed and corrosion of the bearing 3r and the bearing 3t due to flow of the shaft current Ih can be prevented.

Further, as in embodiment 1, since the high-resistance layer 42 covering the surface of the shaft material 41 is provided to the shaft 4F, the shaft current Is can be reduced and the electric energy can be efficiently converted to heat.

That is, according to embodiment 7, as in embodiment 1, by reducing the shaft current Ih, corrosion of the bearings 3 is suppressed and failure of the motor 106 is prevented, and by reducing the shaft current Is, occurrence of an unexpected malfunction of equipment connected to the shaft 4C is suppressed.

Further, regarding the high-resistance layer 42 and the insulating layer 43a, wear of the high-resistance layer 42 and the insulating layer 43a due to the shaft 4F and the rotor 5a rubbing against each other is prevented, whereby the functions of the high-resistance layer 42 and the insulating layer 43a are maintained.

Thus, according to embodiment 7, it is possible to provide the motor 106 that is highly reliable and does not cause an unexpected malfunction on other connected equipment.

In embodiment 7, it has been described that the shaft 4F has the protrusion 41t having a shape protruding in the direction perpendicular to the X direction at a part of the shaft material 41c, the rotor 5a has the recess 5u having a shape partially recessed at a surface thereof contacting with the shaft 4F, and the protrusion 41t and the recess 5u are fitted to each other. However, the shaft 4F may have a recess and the rotor 5a may have a protrusion so that the recess and the protrusion are fitted to each other. That is, any structure may be employed as long as the shaft 4F and the rotor 5a are fitted and connected to each other.

In the present disclosure, within the scope of the invention, the embodiments may be freely combined, or each embodiment may be modified or simplified as appropriate. For example, embodiment 2 and embodiment 4 may be combined with each other so that the high-resistance-layer exposed portion 44 and the high-thermal-conductivity layer 45 are both provided. Alternatively, embodiment 5 and embodiment 6 may be combined with each other so that the fins 46 and the flow path 47 are both provided.

### DESCRIPTION OF THE REFERENCE CHARACTERS

1 case

2 stator

3, 3r, 3t, 3A, 3Ar, 3At bearing

4, 4A, 4B, 4C, 4D, 4E, 4F shaft

5, 5a rotor

5u recess

41, 41a, 415, 41c shaft material

41t protrusion

42 high-resistance layer

43, 43a, 43n, 43u insulating layer

44 high-resistance-layer exposed portion

45 high-thermal-conductivity layer

46 fin

47 flow path

100, 101, 102, 103, 104, 105, 106 motor

1.-8. (canceled)

9. A motor comprising:
an electrically conductive case;
a shaft stored in the case and placed such that a part of the shaft penetrates the case; and
a bearing via which the shaft is rotatably attached to the case, wherein
the shaft has an electrically conductive shaft material, and a high-resistance layer covering a surface of the shaft material and having a higher electric resistance than the shaft material.

10. The motor according to claim 9, further comprising a rotor stored in the case and fixed to the shaft, wherein
the shaft and the rotor are electrically insulated from each other with a first insulating material therebetween, the first insulating material having a higher electric resistance than the high-resistance layer.

11. The motor according to claim 10, wherein
the shaft and the case are electrically insulated from each other with a second insulating material therebetween, the second insulating material having a higher electric resistance than the high-resistance layer.

12. The motor according to claim 10, further comprising a stator fixed to the case and placed so as to surround the rotor.

13. The motor according to claim 11, wherein
the first insulating material and the second insulating material are formed on a surface of the high-resistance layer.

14. The motor according to claim 11, wherein
the bearing is made of an electrically insulating material and serves also as the second insulating material.

15. The motor according to claim 10, wherein
the shaft has the first insulating material formed on a surface of the high-resistance layer, and a high-resistance-layer exposed portion where the surface of the high-resistance layer is exposed.

16. The motor according to claim 9, wherein
the shaft has, on a surface of the high-resistance layer, a high-thermal-conductivity layer made of a member having a higher thermal conductivity than the high-resistance layer.

17. The motor according to claim 10, wherein
the shaft has the shaft material, the high-resistance layer, the first insulating material formed on a surface of the high-resistance layer, and a heat dissipation fin.

18. The motor according to claim 9, wherein
the shaft has a flow path through which a coolant flows.

19. The motor according to claim 10, wherein
one of the shaft and the rotor has a protrusion, and another thereof has a recess, and
the protrusion and the recess are fitted to each other so that the shaft and the rotor are connected to each other.
